(19) United States
(12) Patent Application Publication
(10) Pub. No.: US 2026/0164296 A1
(43) Pub. Date: Jun. 11, 2026

(54) RELEVANCE-BASED DYNAMIC RATE THROTTLING FOR LIVE, VIRTUAL, AND CONSTRUCTIVE (LVC) NETWORK INFRASTRUCTURE

(71) Applicant: Rockwell Collins, Inc., Cedar Rapids, IA (US)

(72) Inventors: Jonathan D. Drahos, Belle Plaine, IA (US); Thomas W. Klauer, Tiffin, IA (US)

(21) Appl. No.: 19/415,488

(22) Filed: Dec. 10, 2025

Related U.S. Application Data
(60) Provisional application No. 63/730,550, filed on Dec. 11, 2024.

(51) Int. Cl. H04W 28/02; H04L 41/12; H04W 28/06

(52) U.S. Cl. CPC H04W 28/0268; H04L 41/12; H04W 28/06

(57) ABSTRACT

A transmitting node of a network of nodes operating in a live, virtual, and constructive (LVC) network environment receives updates as to the location or other attributes of entities posing a potential threat to the network or to nodes thereof. In order to conserve network resources and allow an optimal number of participants without undue latency or loss of bandwidth, the node dynamically throttles the update rate for transmitting entity updates to nodes of the network based on the relevance of the entity update to each receiving node; for example, an entity update may be more relevant to nodes proximate to the entity and less so to more distant nodes. Further, the transmitting node may select an optimal antenna for transmission of entity updates to receiving nodes based on an antenna's proximity to, or prior contact with, a receiving node.

### CROSS-REFERENCE TO RELATED APPLICATIONS

The present application is related to and claims the benefit of the earliest available effective filing dates from the following listed applications (the “Related Applications”) (e.g., claims earliest available priority dates for other than provisional patent applications (e.g., under 35 USC § 120 as a continuation in part) or claims benefits under 35 USC § 119(e) for provisional patent applications, for any and all parent, grandparent, great-grandparent, etc. applications of the Related Applications).

### RELATED APPLICATIONS

U.S. Provisional Patent Application Ser. No. 63/730,550 filed Dec. 11, 2024 and titled RELEVANCE-BASED DYNAMIC RATE THROTTLING FOR LIVE, VIRTUAL, AND CONSTRUCTIVE (LVC) NETWORK INFRASTRUCTURE;
   Said U.S. Provisional Patent Application 63/730,550 is herein incorporated by reference in its entirety.

### GOVERNMENT SUPPORT

This technology was developed with United States government support under contract number N61340-17-C-0007 awarded by the Naval Air Warfare Center. The United States government has certain rights in this invention.

### BACKGROUND

Tactical and training networks are often constrained by the datalinks that transmit and receive mission data. Additionally, live, virtual, and constructive (LVC) training exercises require a large amount of data to be shared between participants and ground-based networks to promote effective training. In traditional LVC environments, there is little discrimination in data sharing, regardless of the relevance of shared date to the receiving entities. Often tradeoffs are made between high data rates, and more exercise participants.

### SUMMARY

In a first aspect, a node of a live, virtual, and constructive (LVC) network environment is disclosed. In embodiments, the node may include one or more communications interfaces, e.g., for reception and transmission, and a set of transmitting antennas for transmitting radio frequency (RF) signals to a network of receiving (Rx) nodes, e.g., mobile platforms or fixed-location stations. The node may include a control processor and memory configured for storage of encoded instructions executable by the processor, as well as entity status data including the locations and any other known information associated with entities known to the node and which may present a threat to, or may attempt to detect or scan, some or all of the network nodes or participants. The memory may further store node status data including the locations, capabilities, and/or performance characteristics of each participating node of the network. An entity filter running on the control processor may, according to the encoded instructions, receive node status updates, e.g., changes in location or other attributes of a given participant node. Similarly, the entity filter may receive entity status updates indicative of changes in location or other parameters of an entity. The entity filter may, based on the proximity of the entity location to the location of an Rx node, and/or other criteria determining the relevance of a given entity status update to the Rx node, throttle up or down (i.e., increase or decrease) the update rate at which a received entity status update is forwarded to the Rx node. The transmitting node may include a range manager for selecting an optimal antenna for transmission of the entity status update to the Rx node at the adjusted update rate, e.g., the antenna closest to the Rx node's location or with which the Rx node has previously established a connection. The range manager may transmit the entity status update to the Rx node at the adjusted update rate via the selected optimal antenna.

In some embodiments, the Rx node may be an aircraft, vehicle, or other mobile platform, and the node update may include a current heading and/or acceleration of the Rx node.

In some embodiments, the mobile platform may receive the entity status update via a bus filter controlling data access to a data bus via which displays, instrumentation, and/or subsystems of the mobile platform receive data updates. The bus filter may select from the received entity status update only those portions compatible with the mobile platform's subsystems, preventing the forwarding of incompatible portions via the data bus.

In some embodiments, the entity may include sensors for monitoring, detecting, and/or scanning the Rx node (or other nodes of the network), and the entity status update may be indicative of the range, beam direction, orientation, and/or other sensor capabilities of the entity.

In some embodiments, when the location of the Rx node is incompatible with the sensor capabilities of the sensing entity, e.g., the sensing entity is not able to detect or scan the Rx node (and the entity is therefore not currently relevant to the Rx node), the entity filter may block or prevent entirely transmission of the entity status update to the Rx node.

In some embodiments, the entity may be a live weapon, platform, or emitter, e.g., a physical platform controlled by a human operator.

In a further aspect, a method for dynamic update rate optimization within an LVC network environment is disclosed. In embodiments, the method may include providing, to an entity filter executing on a controller of a transmitting (Tx) node of an LVC network, entity information including the location of entities known to the Tx node that may present a threat to, or may attempt to detect or scan, one or more nodes of the LVC network. The method may include receiving, via the entity filter, node updates from receiving (Rx) nodes in communication with the Tx node, the node updates indicative of changes in location or other status parameters of the Rx node. The method may include receiving entity status updates indicative of location changes (or other status changes) of a known entity. The method may include throttling up or down, e.g., increasing or decreasing, the update rate at which a received entity status update is transmitted to the Rx node based on the relevance of the entity status update to the Rx node (which relevance may be based on the proximity of the entity to the Rx node and/or other relevance criteria). The method may include selecting, via a range manager of the Tx node, an optimal antenna for transmitting the entity status update to the Rx node, based on the throttled update rate, the proximity of the antenna to the Rx node, and/or prior communications between the antenna and the Rx node. The method may include transmitting the entity status update to the Rx node via the selected optimal antenna at the throttled update rate.

In some embodiments, the Rx node may include an aircraft, vehicle, or other mobile platform, and the node update and/or node location of the Rx node may include a heading and/or an acceleration of the mobile platform.

In some embodiments, the method may further comprise receiving the transmitted entity status update via a bus filter of the mobile platform, e.g., the bus filter controlling access to a data bus via which instrumentation, displays, and subsystems of the mobile platform receive updates. The method may include filtering the received entity status update via the bus filter by selecting only those portions of the entity status update compatible with the aircraft subsystems for forwarding to the subsystems of the mobile platform.

In some embodiments, the entity may include one or more sensors capable of, e.g., detecting and/or scanning the Rx node (and/or other nodes of the LVC network); accordingly, the entity status update may be indicative of, or a change of, sensor capabilities including range, beam direction, and/or orientation of the sensor/s.

In some embodiments, when the location of the Rx node is incompatible with the sensor capabilities of the entity, e.g., when the entity cannot detect and/or scan the Rx node because the sensors are oriented away from the Rx node, the method may include blocking or preventing, via the entity filter, transmission of the entity status update to the Rx node.

In some embodiments, the entity may include a live emitter, weapon, or platform, e.g., a physical platform controlled by a human operator.

In some embodiments, the entity may include a constructive emitter, weapon, or platform, e.g., a simulated platform at least partially controlled by a human operator, e.g., via human-in-the-loop.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a diagrammatic illustration of a live, virtual, and constructive (LVC) network environment according to with example embodiments of this disclosure;

FIG. 2 is a block diagram illustrating components and operations of the LVC environment of FIG. 1;

and FIGS. 3A and 3B are flow diagrams illustrating a method for dynamic rate throttling according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Broadly speaking, embodiments of the inventive concepts disclosed herein are directed to systems and methods for dynamic throttling of update rates between nodes of a live, virtual, and/or constructive (LVC) network. The inventive concepts disclosed herein may be utilized and implemented for stationary ground-based mission rooms and radio frequency (RF) range managers, but also aboard airborne platforms, land-based vehicles, water-based or submersible vehicles, aeronautical or orbital platforms, and/or satellites. Embodiments of the inventive concepts disclosed herein may provide for larger LVC networks or systems, e.g., including a greater number of participants or components, without unduly constraining throughput across the network. For example, the update rates at which LVC mission data is transmitted across the network, as well as the quantities or types of mission data transmitted, may be throttled up or down on a continual and dynamic basis according to the relevance of entities receiving said mission data relative to the data being transmitted. The relevance of a receiving entity may be determined by one or more factors, or by a variety of different weighted factors, such as the proximity of the recipient to the transmitting node and/or the capability of the receiving node to utilize the transmitted mission data. Similarly, bus filtering aboard mobile platforms may regulate the distribution of received LVC mission data to instruments and/or subsystems of the mobile platform according to the capacity of each instrument or subsystem to effectively utilize the mission data as it arrives.

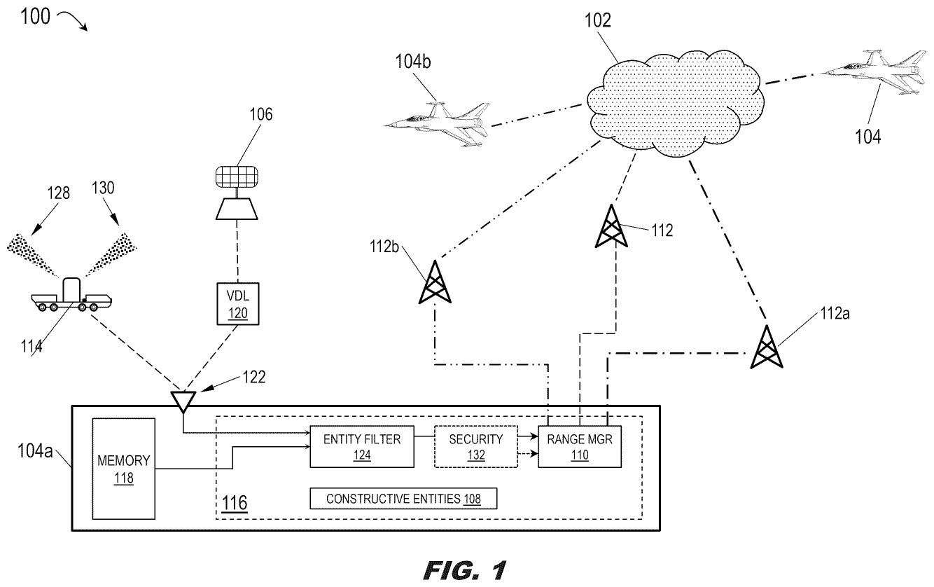

Referring now to FIG. 1, a schematic diagram of a live/virtual/constructive (LVC) network environment 100 is shown. In embodiments, the LVC network environment 100 may include a network 102 (e.g., a radio frequency (RF) network generally compatible with transmissions in the RF bands of the electromagnetic spectrum, comprising frequencies between 3 Hz and 3 THz) configured to facilitate communication between nodes 104 of the network 102 (e.g., live aircraft, platforms, or other participants in the network), virtual platforms or entities 106, and constructive entities 108 (e.g., constructive emitters, weapons, or platforms). For example, the LVC environment 100 may include any number of live nodes 104 and virtual/constructive platforms 106, 108, although the network 102 may additionally be configurable to facilitate communications between other types of platforms or entities not shown here. By way of a non-limiting example, the U.S. Department of Defense's Modeling and Simulation (M&S) Glossary may define live platforms 104 as real-world systems operated by real persons (simulated in the sense that operations are not conducted against a live enemy); virtual platforms 106 as simulated systems operated by real persons (via, e.g., human-in-the-loop in a control, decision-making, and/or communications role); and constructive platforms 108 as simulated systems operated by simulated persons (which, e.g., may receive human input but do not determine outcomes).

In embodiments, live nodes 104 may include piloted vehicles (e.g., piloted airborne platforms, piloted aircraft, trainer aircraft), remotely controlled vehicles (e.g., remotely controlled automobiles or drones, unmanned aircraft), or autonomous vehicles (e.g., unmanned autonomous vehicles). For example, nodes 104 can be configured to communicate with the network 102 via a real or simulated or emulated range RF manager 110 (e.g., range gateway) component of a node 104a (e.g., a transmitting (Tx) node), which may include or be operatively coupled to one or more transmission antennas 112 (e.g., radio tower).

In embodiments, the node 104a may monitor, via one or more live emitters or other physical range equipment, adversaries or other live entities 114 (e.g., weapons, emitters, platforms) that may present a threat to the network 102 or to one or more nodes 104, 104a, virtual platforms 106, and/or constructive entities 108 thereof. For example, the node 104a may include one or more control processors 116 and a memory 118 or other data storage configured for storage of relevant information about each node 104, 104a, virtual platform 106, or constructive platform 108 of the network as well as any entities 114 monitored by or otherwise know to the network. For example, the memory 118 may maintain the location data and specifications or capabilities of all nodes 104, 104a, virtual platforms 106, constructive platforms 108, and entities 114, e.g., performance profiles (where the node, platform, or entity is an aircraft, vehicle, or other mobile platform); virtual data links 120 (VDL; via which the node 104a communicates with virtual platforms); and sensor capabilities (e.g., where the entity includes sensors attempting to detect or monitor the nodes or platforms, such as sensor ranges, beam directions, orientations, resolution, and/or accuracy).

In embodiments, virtual platforms 106 may include simulated platforms, such as tactical cockpit simulators, simulated airborne platforms, command and control (C2) simulations, surveillance platforms, virtual avionics procedure trainer (VAPT) simulations, or other simulated platforms, such as ground vehicle simulations. As compared to the live platforms 104, a greater proportion (e.g., some or all) of the sensor data received by the virtual platforms 106 may be simulated rather than received from physical or live sensors, and control instructions received from an autopilot or user control interface by the virtual platforms may be used to generate simulated responses rather than physical movement or other physical responses. In embodiments, virtual platforms 106 can include or be communicatively coupled to a VDL 120, which may simulate or emulate electronic communications (e.g., wireless communications) between multiple virtual platforms, or may simulate a communication interface by which the virtual platforms communicate with the network 102 and the live or constructive platforms 104, 108, 110. Further, the virtual platforms 106 may also include communications devices 112 configured to directly receive signals from, and transmit signals to, the live platforms 104.

In embodiments, constructive platforms 108 may include computer-generated platforms, such as ground-based platforms (e.g., surface-to-air threats) or airborne platforms (e.g., air-to-air threats). For example, a simulation engine (not shown) may execute a platform model associated with characteristics of the constructive platforms 108, e.g., movement ability, communications ability. As compared to the virtual platforms 106, the constructive platforms 108 may be fully software-based, and/or may not be configured to be controlled by a user or by an autopilot as complex as an autopilot for a virtual platform.

In embodiments, the control processors 116 may be implemented as a specific purpose processor, an application specific integrated circuit (ASIC), one or more field programmable gate arrays (FPGAs), a group of processing components, or other suitable electronic processing components. Similarly, the memory 118 may include one or more devices (e.g., RAM, ROM, flash memory, hard disk storage) for storing data and computer code for completing and facilitating the various user or client processes, layers, and modules described in the present disclosure. In embodiments, the memory 118 may be or include volatile memory or non-volatile memory and may include database components, object code components, script components, or any other type of information structure for supporting the various activities and information structures of the inventive concepts disclosed herein. Further, the memory 118 may be communicably connected to the control processor/s 116 and may include computer code or instruction modules for executing one or more processes described herein. Similarly, the memory 118 may include various circuits, software engines, and/or modules that cause the control processor/s 116 to execute the systems and methods described herein.

In embodiments, the node 104a may receive, e.g., via one or more communications interfaces 122, entity update data from or about one or more entities 114 known to the node. For example, entity update data may include changes in the location of an entity 114 (where the entity is a mobile platform) or changes in sensor capabilities or configuration (where the entity includes sensors capable of adjusting orientation, beam width, signal strength, or other parameters of interest to the network 102).

In embodiments, the node 104a may receive, e.g., via the communications interfaces 122 or via data links established through the transmission antennas 112, node updates from one or more nodes 104, virtual platforms 106, or constructive platforms 108. For example, node updates may include changes in the location of a node 104 (e.g., where the node is an aircraft or mobile platform; changes in location may further include changes in heading, velocity, and/or acceleration of a mobile platform) or other configuration changes to a node or platform.

Broadly speaking, the LVC environment 100 may be characterized by a finite level of available throughput that corresponds to an upper bound on the number of nodes 104 or participants in the network 102 (see FIG. 1). For example, it may be possible for additional nodes 104 or participants above and beyond this upper bound to participate in operations within the LVC environment 100, but a lack of data discrimination within the network leads to constraints on the available throughput due to the additional participants.

In embodiments, the LVC environment 100 and network 102 may provide for larger sets of nodes 104 or participants without the corresponding network strain by throttling the transmission of LVC mission data throughout the network according the current relevance of said LVC mission data to the prospective recipients. For example, the relevance of entity update data (e.g., received from or associated with a live emitter or other entity 114 monitored by the node 104a) transmitted to a receiving node, e.g., an aircraft or other live platform 104 by the node 104a (e.g., via the range RF manager 110 and/or transmission antenna 112) may be defined in terms of the proximity of the live platform to the entity 114. If, for example, a given entity update from, or relevant to, the entity 114 corresponds to a particular geographic area or region within the LVC environment 100 (e.g., an area where the entity 114 is operating and/or which the entity is monitoring), and the live platform 104 is not only not within this area or region but a significant distance therefrom, the relevance of the entity update to the live platform is likely relatively low, and the node 104a may include an entity filter 124 configured to adjust the update rate of the entity update, e.g., the transmission rate at which the entity update is forwarded to the live platform 104, downward to a relatively low rate. In this way, the node 104a may avoid undue use of throughput or avoid undue strain on the network 102 as a whole by deprioritizing the use of network resources to forward the live platform 104 an entity update of little or no relevant to the live platform.

Similarly, in embodiments the entity filter 124 may prioritize, or increase the update rate for, transmission of the entity update to the live platform 104 if the location of the live platform is proximate to that of the entity 114, or if the entity is relevant to the live platform according to other criteria.

In embodiments, the entity filter 124 may maintain full knowledge of any operations within the LVC environment 100 as well as the locations, capabilities, and limitations of any range RF managers 110, live platforms 104, virtual platforms 106, constructive platforms 108, and/or entities 114. For example, the locations of live platforms 104 (e.g., non-stationary aircraft, water-based, or ground-based vehicles) may be monitored based on position reports received from the live platforms, e.g., via communications interfaces 122. In embodiments, the entity filter 124 may forward entity updates to the range RF manager 110 for transmission to the live platforms 104 at the adjusted transmission rate for each live platform.

In embodiments, live platforms 104 operating within the LVC environment 100 (as well as, to some extent, virtual platforms 106 or constructive platforms 108) may be non-stationary vehicles or, in particular, aircraft capable of highly dynamic movement patterns characterized by high speeds and acceleration rates as well as frequent shifts in orientation due to aircraft maneuvering. For example, the entity filter 124 may increase or decrease the update rate for transmission of a particular entity update to a particular live platform 104 based not only on the proximity of the live platform to the relevant entity 114, but additionally considering the acceleration and/or heading of the live platform. If, for example, the live platform 104 is currently proximate to the entity 114 but accelerating away from the entity, the entity filter 124 may deprioritize transmission of the entity update to the live platform despite its close proximity. Similarly, the update rates for transmitting entity updates relevant to a particular entity 114 to a particular live platform 104 may be dynamically updated if, for example, the proximity or other relevance criteria relative to the entity and to the live platform continue to vary.

In embodiments, the entity filter 124 may dynamically throttle (e.g., increase or decrease) the update rates for transmitting entity status updates based on sensor capabilities, sensor limitations, or other sensor/component status factors associated with an entity 114. For example, the entity 114 may be relatively proximate to a live platform 104b, but scanning in a direction 128 oriented away from the live platform and/or its operating area. When the sensors of the entity 114 are oriented in such a way (e.g., with respect to antenna orientation, beam direction, signal strength) that the entity would not be able to “see” or detect the live platform 104b, then entity updates associated with the entity 114 may be less relevant, or not relevant, to the live platform 104b. Accordingly, in embodiments the entity filter 124 may throttle down the update rate for transmitting entity status updates associated with the entity 114 to the live platform 104b. In some embodiments, while the sensors of the entity 114 are oriented away from the live platform 104b, the entity filter 124 may conserve bandwidth by blocking or otherwise preventing transmission of entity updates associated with the entity to the live platform.

Similarly, while the live platform 104 may be at a greater distance from the entity 114, the entity's sensors may be scanning in a direction 130 toward the live platform (such that the live platform may be detected, monitored, or otherwise “seen” by the entity). Accordingly, in embodiments the entity filter 124 may throttle up or increase the update rate for transmission of entity updates to the live platform 104b to account for the sensor orientation of the entity. In other embodiments, the entity filter 124 may throttle upward or downward update rates for transmission of entity updates associated with a particular entity 114 based on the accuracy or resolution of the entity's sensors relative to a receiving live platform 104, 104b.

As discussed above, the entity filter 124 may direct the RF range manager 110 to transmit entity updates to the live platforms 104, 104b at adjusted update rates throttled upward or downward. In embodiments, the RF range manager 110 may further conserve network resources by dynamically selecting from among available antennas 112 an optimal antenna for transmission of entity updates to each live platform 104, 104b. For example, the antennas 112, 112a-112b may be available to the RF range manager 110 for transmission; the antenna 112a may be closest to the last reported location of the live platform 104, so the RF range manager may select the antenna 112a for transmission of entity updates to the live platform 104 (subject to further changes in location, orientation, or direction on the part of the live platform). Similarly, in embodiments the RF range manager 110 may select the antenna 112b for transmission of entity updates to the live platform 104b based on prior links, communications, or contact between the live platform and the antenna.

In some embodiments, the node 104a may include one or more security infrastructures 132, e.g., cryptographic units, firewalls, cross-domain solutions. For example, security infrastructures 132 may be positioned between the entity filter 124 and RF range manager 110. While, for example, deep packet inspection, firewalls, and other security infrastructures 132 may introduce a degree of bottlenecking into a conventional network, dynamic throttling of update rates via the entity filter 124 and/or optimal transmitter selection via the RF range manager 110 may allow the security infrastructures 132 to filter entity updates and other data traffic between the entity filter 124 and RF range manager 110 according to applicable security rules without significant adverse effects on network throughput.

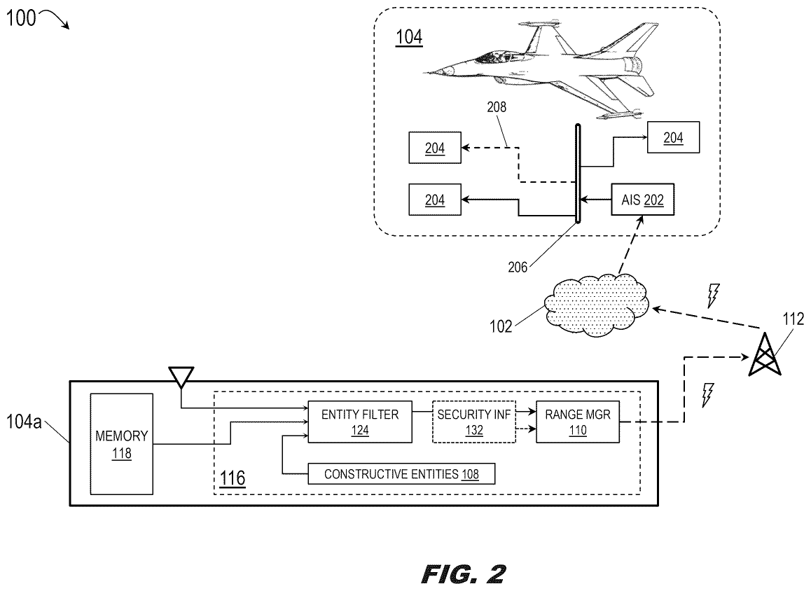

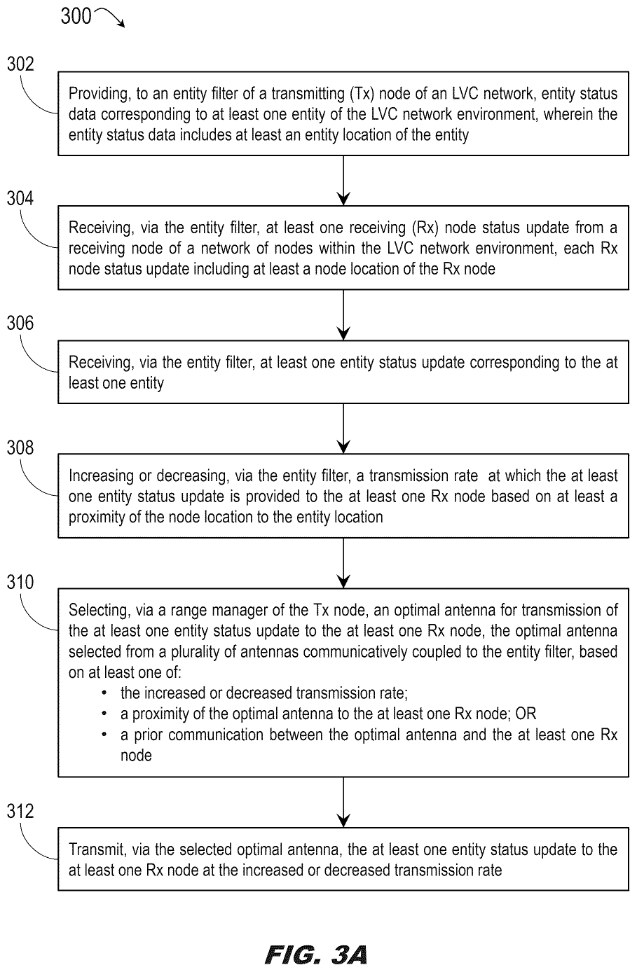

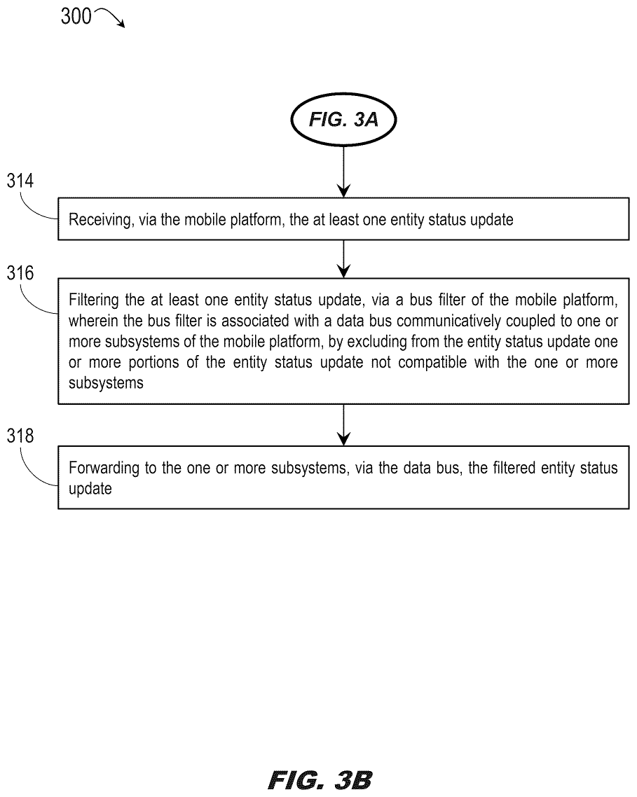

Referring now to FIG. 2, the LVC network environment 100 is shown.

In embodiments, live platforms 104 receiving entity updates from the node 104a (e.g., and thereby dynamically throttled and/or optimized by the entity filter 124 and/or RF range manager 110) may provide additional bus-level filtering of received entity updates. For example, aircraft data bus filters incorporated into an Airborne Instrumentation System 202 (AIS) or like data acquisition system aboard the live platform 104 may control access to received entity updates by other aircraft displays, instrumentation, and/or subsystems 204 receiving information via aircraft data bus 206. In embodiments, the AIS aircraft data bus filters 202 may filter out or remove portions of the entity updates with which the subsystems 204 are incompatible. For example, some live platforms 104 (or subsystems 204 thereof) within the LVC environment 100 may not be advanced enough or sufficiently equipped to consume the entire set of entity update data. Similarly, entity update status data received by the live platform 104 at a faster than necessary update rate may not be relevant to subsystems not requiring a high data rate. Likewise, entity update status data received by the live platform at too low a data rate may not be relevant if updates are provided too slowly to keep up with the speed of the live platform. Accordingly, said entity update data (or specific portions thereof) may not be relevant to the live platform 104 or its subsystems 204. In embodiments, the AIS aircraft data bus filters 202 may block (e.g., filter, prevent) platform-level distribution of any entity status updates (208) not relevant to, or not consumable by, any components or subsystems 204 of that platform. Accordingly, the aircraft data bus 206 may avoid unnecessary constraints caused by the forwarding of entity update data not relevant or useful to aircraft subsystems 204.

Referring now to FIG. 3A, the method 300 may be implemented by the node 104a within the LVC environment 100 and may include the following steps.

At a step 302, an entity filter of a transmitting (Tx) node of an LVC network, e.g., a mission room with full knowledge of all participating nodes of the network, receives entity status data (including a location of the entity) of an emitter, weapon, or other entity of interest to one or more nodes of the network. For example, the entity may be an adversary or unknown, or may be attempting to detect or surveil one or more nodes. The entity may be a live emitter or weapon, or a software-drive constructive entity.

At a step 304, the Tx node receives a node status update from one or more nodes of the network. For example, one or more nodes may be aircraft or other mobile platforms subject to dynamic shifts in location, velocity, heading, and/or acceleration. The entity filter may monitor the location, heading, acceleration, and/or other parameters of nodes with which the Tx node is in communication or contact.

At a step 306, the node receives an entity status update indicative of a change in status of one or more entities. For example, an entity status update may indicate a change in location, e.g., for mobile entities; a change in participation status, e.g., still participating (or no longer participating) in a mission or exercise; or a change in sensor configuration (e.g., orientation, beam direction, signal strength) for entities incorporating sensors.

At a step 308, the entity filter dynamically throttles the update rate used for transmitting the entity update to one or more nodes of the network based on one or more criteria defining a relevance of the entity status update to the receiving node. For example, if a receiving node is proximate to the entity, the entity filter may increase the update rate, prioritizing transmission of the entity update to that node. Similarly, if a receiving node is distant from the entity, the entity filter may decrease the update rate to avoid using undue network resources to transmit data of little or no relevance to the receiving node. In some embodiments, e.g., when the entity includes one or more sensors, the entity filter may throttle down the update rate for transmission of entity updates associated with the sensor entity, or block transmission entirely of said entity updates, to a receiving node when the receiving node is not detectable by the sensor entity. In some embodiments, the entity filter may consider other relevance factors, such as the accuracy and/or resolution of a sensor entity.

At a step 310, a range RF manager of the Tx node selects from a set of antennas an optimal antenna or other communications device for transmission of the entity update to the receiving node at the adjusted update rate based on one or more additional relevance criteria. For example, the range RF manager may select an optimal antenna for transmission of entity updates to a receiving node based on a proximity of the receiving node to the antenna, or based on prior communications links established with the receiving node via the selected antenna.

At a step 312, the Tx node transmits the entity update to the receiving node at the adjusted update rate via the selected optimal antenna.

Referring also to FIG. 3B, the method 300 may include additional steps 314 through 318. At the step 314, a communications interface of the Rx node, e.g., an Airborne Instrumentation System (AIS) based aircraft data bus filter aboard the mobile platform, receives the transmitted entity update from the Tx node.

At a step 316, the data bus filter excludes from the entity status update portions not compatible with downstream instrumentation, components, subsystems, or displays served by the aircraft data bus. For example, if the aircraft subsystems are not equipped to consume portions of the entity status update, the aircraft data bus filter will not pass these portions on to the data bus for distribution.

At the step 318, the data bus filter forwards the filtered (non-excluded) portions of the entity update to the subsystems of the mobile platform, e.g., via the aircraft data bus.

The method 300 may include an additional step 320. At the step 320, security modules (e.g., firewalls, cross domain solutions, cryptography modules) filter entity updates and/or other data traffic en route from the entity filter to the range RF manager for transmission, e.g., via removal of portions of the entity status update or encryption of some or all of the entity status update according to applicable security rules.

### CONCLUSION

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. A node of a live, virtual, and constructive (LVC) network environment, the node comprising:
at least one communications interface;
one or more transmitting (Tx) antennas configured for transmitting radio frequency (RF) signals to a network of nodes within the LVC network environment;
at least one control processor operatively coupled to the at least one communications interface and to the one or more Tx antennas;
a memory configured for storage of:
entity status data corresponding to one or more entities associated with the LVC network environment, the entity status data including at least an entity location of the one or more entities;
node status data corresponding to at least one node of the network;
and
encoded instructions executable by the at least one control processor;
wherein the at least one control processor is configurable by the encoded instructions to:
receiving, via the at least one communications interface, at least one receiving (Rx) node status update from a receiving node of the network, each Rx node status update including at least a node location of the Rx node;
receive, via the at least one communications interface, at least one entity status update associated with a first entity of the one or more entities;
increase or decrease, via an entity filter, a transmission rate at which the at least one entity status update is forwarded to the at least one Rx node based on at least a proximity of the entity location to the node location;
select from the one or more Tx antennas, via an RF range manager, an optimal antenna for transmission of the at least one entity status update to the at least one Rx node based on at least one of:
the increased or decreased transmission rate;
a proximity of the optimal antenna to the at least one Rx node; or
a prior communication between the optimal antenna and the at least one Rx node;
and
transmit, via the selected optimal antenna, the at least one entity status update to the at least one Rx node at the increased or decreased transmission rate.

2. The node of claim 1, wherein the at least one Rx node includes at least one mobile platform, and the node location of the at least one Rx node includes one or more of:
a heading of the Rx node;
or
an acceleration of the Rx node.

3. The node of claim 2, wherein the at least one mobile platform is configured to:
receiving, via a bus filter associated with a data bus, the data bus communicatively coupled to one or more subsystems of the mobile platform, the at least one entity status update;
filter, via the bus filter, the at least one entity status update by selecting from the entity status update only those portions of the entity status update compatible with the one or more subsystems;
and
forward, via the data bus, the filtered entity status update to the one or more subsystems.

4. The node of claim 1, wherein the at least one entity includes at least one sensor, and the entity status data includes at least one of:
a range of the at least one sensor;
a beam direction of the at least one sensor;
or
an orientation of the at least one sensor.

5. The node of claim 4, wherein the entity filter is configured to:
when the node location of the at least one Rx node is incompatible with at least one of the range, the beam direction, or the orientation of the at least one sensor, blocking transmission of the at least one entity status update to the at least one Rx node.

6. The node of claim 1, wherein the at least one entity includes a live emitter.

7. The node of claim 1, wherein the at least one entity includes at least one of a constructive emitter or a constructive platform.

8. A method for dynamic rate optimization within a live, virtual, and constructive (LVC) network environment, the method comprising:
providing, to an entity filter of a transmitting (Tx) node of an LVC network, entity status data corresponding to at least one entity of the LVC network environment, wherein the entity status data includes at least an entity location of the entity;
receiving, via the entity filter, at least one receiving (Rx) node status update from a receiving node of a network of nodes within the LVC network environment, each Rx node status update including at least a node location of the Rx node;
receiving, via the entity filter, at least one entity status update corresponding to the at least one entity;
increasing or decreasing, via the entity filter, a transmission rate at which the at least one entity status update is provided to the at least one Rx node based on at least a proximity of the node location to the entity location;
selecting, via a range manager of the Tx node, an optimal antenna for transmission of the at least one entity status update to the at least one Rx node, the optimal antenna selected from a plurality of antennas communicatively coupled to the entity filter, based on at least one of:
the increased or decreased transmission rate;
a proximity of the optimal antenna to the at least one Rx node;
or
a prior communication between the optimal antenna and the at least one Rx node;
and
transmitting, via the selected optimal antenna, the at least one entity status update to the at least one Rx node at the increased or decreased transmission rate.

9. The method of claim 8, wherein the at least one Rx node includes at least one mobile platform, and the node location of the Rx node includes one or more of:
a heading of the Rx node;
or
an acceleration of the Rx node.

10. The method of claim 9, further comprising:
receiving, via the mobile platform, the at least one entity status update;
filtering the at least one entity status update, via a bus filter of the mobile platform, wherein the bus filter is associated with a data bus communicatively coupled to one or more subsystems of the mobile platform, by selecting from the entity status update only those portions of the entity status update compatible with the one or more subsystems;
and
forwarding to the one or more subsystems, via the data bus, the filtered entity status update.

11. The method of claim 8, wherein the at least one entity includes at least one sensor, and the entity status data includes at least one of:
a range of the at least one sensor;
a beam direction of the at least one sensor;
or
an orientation of the at least one sensor.

12. The method of claim 11, wherein increasing or decreasing the transmission rate includes:
when the node location is incompatible with at least one of the range, the beam direction, or the orientation of the at least one sensor, blocking transmission of the at least one entity status update to the at least one Rx node.

13. The method of claim 8, wherein the at least one entity includes a live emitter.

14. The method of claim 8, wherein the at least one entity includes at least one of a constructive emitter or a constructive platform.
